(19) United States
(12) Patent Application Publication
(10) Pub. No.: US 2012/0235529 A1
(43) Pub. Date: Sep. 20, 2012

(54) DEVICE AND METHOD EMPLOYING MAGNETIC AND GRAVITATIONAL ENERGY FOR MECHANICAL POWER

(76) Inventor: John Hunter, El Cajon, CA (US)

(21) Appl. No.: 13/424,303

(22) Filed: Mar. 19, 2012

Related U.S. Application Data
(60) Provisional application No. 61/454,112, filed on Mar. 18, 2011.

(51) Int. Cl. H02K 21/00; H02N 11/00

(52) U.S. Cl. 310/152; 74/DIG. 9

(57) ABSTRACT

A device for imparting rotation to a rim using magnetic attraction to induce gravitational pull upon a rolling component to a higher position upon an interior surface of a rim thereby inducing a roll of said rim in a direction of an adjacent magnet. The device may be engaged to generators and the like to provide rotational power and is adapted to function as a toy which will roll across a support surface in either of two directions.

This application claims priority to U.S. Provisional Application Ser. No. 61/454,112, filed on Mar. 18, 2011, and included herein in its entirety by this reference thereto.

### BACKGROUND OF THE INVENTION

1. Field of the Invention

The present invention relates to energy capture and conversion. More particularly, it relates to a device employing magnetic energy or force as a means to augment and harness gravitational potential energy, and translate it to kinetic energy for performing work. The device and method are employable for both an energy source and a toy in smaller scale.

2. Prior Art

Human beings have always looked for new ways of transportation by designing and employing widely different means for powering mechanical devices. Modernly, powering mechanical devices such as weaving mills, pumps, vehicles, and other mechanical devices, requires the communication of mechanical power from motors, engines, or other means for imparting force for work, to a rotating shaft or wheel. The power is then communicated using gears, shafts, and belts, to various machine components, all of which act in concert with the delivered rotational power, to perform work such as a mechanical task.

In the past, power captured to run machinery in such a fashion has come from animals pulling or rotating wheels, wind or other force causing rotating shafts, water wheels, windmills, steam engines, and more modernly internal combustion engines. Such means to capture potential energy from fuels, or natural energy from moving or falling water, or wind, have continued to evolve over decades and continue today. However, with modern energy requirements increasing exponentially, and conventional sources dwindling, there is a never ending need to find new and untapped sources of power that can be easily converted and communicated to machinery to provide the power to perform work.

In general, the laws of physics dictate that in order to move an object or rotate a wheel, potential energy such as fuels, battery-stored electricity, upstream reservoirs of water and the like, must be converted from potential energy to kinetic energy, or energy in motion capable of providing power to perform work (internal combustion engine, electric motor, etc.). Nature provides huge sources of potential energy in the form of fossil fuels, and lakes and reservoirs as well as moving force such as flowing water, and wind. A generally overlooked and under harnessed source of energy, while frequently employed with water power, is that of gravity, and that of magnetic attraction. While gravity in the form of the force of falling water or even rolling a wheeled vehicle downhill, is employed widely, the capturing and conversion of the gravitational forces themselves, into a mechanical power source, has not been perfected.

Modernly, there is an ever dwindling supply of fossil fuel, and increasing known hazards associated with damming rivers for building potential energy sources for water power. Wind power continues to suffer an inability to capture wind energy and convert it to electricity at times and in communication to the power grids which most need the generated electricity. This is because wind blows in an unpredictable fashion and in general at times when the grid does not need the electrical power, which cannot at present be economically stored.

It is known in the art that the attractive forces of magnetic fields can be harnessed to produce mechanical power. For example, most electric motors operate through the interaction of magnetic fields and current-carrying conductors. Briefly, magnetic fields formed on both the rotor and stator gives rise to a force, which ultimately produce torque on the motor shaft. This is conventionally accomplished by switching the poles on and off at the right time. However, there has been little to no efforts in prior art in combining magnetic attractive forces with the potential energy of gravitational forces as a catalyst enabling the harnessing or storing of such energy.

As such, there is a continued unmet need to harness new and untapped energy sources which may be employed for the betterment of mankind, such as gravitational and magnetic sources of power in combination, as a means to generate and deliver mechanical power which may be employed directly for work or converted to electrical power which may be delivered remotely to power motors and electrical devices on a grid.

### SUMMARY OF THE INVENTION

The device and method of employment herein disclosed and described, provides a means to induce rotation to a rotatable body through the provision of a field generating magnet and a rotor device coupled into a rotating body system. The device advantageously harnesses the attractive and repellent forces of magnets, preferably rare earth type magnets which produce significantly stronger magnetic fields than conventional iron-based magnets. The magnetic attraction of the magnet or magnets services to combine with gravity in forming a component capable of the generation of mechanical power to rotate. This rotation is accomplished through an interaction or combination of the magnetic attraction of the magnet to act to change the center of gravity of a wheel, which then rotates through the effects of gravitational forces thereon.

The device features a non-magnetic preferably magnetically inert outer rim component, which forms a hollow circular body. The interior of the circular body portion surrounds a ferromagnetic rotor which has a diameter less than that of the circular body. The ferromagnetic rotor is positioned or engaged in a manner that it is adapted to rotate within the internal circumference of the circular body. The rotor in combination with the circular body having a hollow interior, comprise a rotating body.

Additionally employed in the formation of the device is an arm formed of a member or opposing members which projects in a direction away from the hollow interior and circumference of the rotating body. The distal end of the projecting member is configured to engage a permanent magnet and hold it a fixed distance from the rotating body whether stationary or moving. Preferably, such a permanent magnet is formed as a rare earth magnet formed of neodymium or other rare earth magnet materials to enhance performance of the formed device through the projection of a stronger magnetic field therefrom.

The arm is rotatably engaged to the outer rim to thereby provide a means to position a stationary permanent magnet to maintain a fixed distanced location, spaced from the circumference of the outer rim during rotation thereof.

In use, with the permanent magnet stationarily positioned relative to the rotating body, the initially stationary rotor member configured to rotate within the internal circumference of the body, is magnetically attracted to the magnet and begins to rotate, or roll, towards it. Because the circular rotor is of a smaller diameter than that of the body, the rotor rotating in its attraction to the stationary magnet begins to climb the inner wall surface or circumference of the circular shaped body, in its effort to approach the magnet.

At a certain point during this rotational attraction, the rotor, acting against the internal circumference surface of the body, reaches a point above the surface of the circular body at which it displaces the center of gravity of the circular body sufficiently higher to subsequently cause the body to rotate as well. At this point the coupled rotating body and internal rotor are driven forward toward the direction of the stationarily positioned magnet, due to the induced rotary motion wherein the body acts as a rim or wheel. The continued attraction of the rotor to the positional spaced magnet held in its spaced engagement continues the rotation of the rotor against the inside circumferential surface of the body which forms a rim component, while concurrently building momentum and sustaining rotary motion for the system as a whole.

Thus, by harnessing the magnetic attractive force of the rotor to the stationary magnet to initiate a change of the center of gravity, and allowing the force of gravity on the raised center of gravity to drive the rotational motion of the body, power may be captured to power mechanical devices. For example, the rotating body, sized to generate sufficient force, may be attached to a generator for converting the mechanical energy of the rotating body to electrical energy. Alternatively, the device may be placed within a large wheel attached to a generator, wherein the large wheel is rotated by the rotation of the device and the continued change of gravity center and magnetic attraction causing it, similar to a rodent driving a hamster wheel.

In another particularly preferred mode, in a smaller format, the device is especially well suited as a novelty toy item for entertainment. In this mode, the rotation of the body from the constantly changing center of gravity caused by the magnetic attraction, is employed to translate the device over a support surface. Further, the device may employ an additional arm member extending from the permanent magnet engaged arm member, which will allow the user to actively position the permanent magnet on either side of the rotating body, thus changing its direction. This can be enjoyed by young children at play, as well as a desktop novelty toy item in the office.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and mayor may not be present. By “consisting of is meant including, and limited to, whatever follows the phrase “consisting of”. Thus, the phrase “consisting of” indicates that the listed elements are required or mandatory, and that no other elements may be present. By “consisting essentially of is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and mayor may not be present depending upon whether or not they affect the activity or action of the listed elements.

It is an object of the current invention to provide a means for generating rotational power or energy, through the generation of a rotating body having mass, using a combination with magnetic attraction and gravitational forces.

It is an object of the invention to provide a toy device employing a rotating body employing magnetic attraction and resulting gravitational forces to translate or move across a surface.

It is another object of the invention to provide a translating toy device harnessing magnetic attraction and gravitational forces which a user can actively change the direction of translation.

These together with other objects and advantages which become subsequently apparent, reside in the details of the construction and operation of the device and method as herein described, with reference being had to the accompanying drawings forming a part thereof, wherein like numerals refer to like parts throughout.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a top view of the device depicting the relative location of the magnet to the rotating components.

FIG. 2 shows a side view of the device in stationary mode.

FIG. 3 depicts a side view of the device showing the initial rotation of the rotor element due to it's attraction to the magnet.

FIG. 4 shows the device with rotor element moving towards the magnet causing the rim body to rotate as well.

FIG. 5 shows the device where the rotation of the coupled system has translated to linear forward motion.

FIG. 6 is a top view of another particularly preferred mode of the device having an alternate control arm arrangement such that the device is especially well suited as a novelty toy item.

FIG. 7 shows a side view of the mode the device of FIG. 6 in a first preferred as used position.

FIG. 8 shows a side view of the mode of the device of FIG. 6 in a second preferred as used position.

### DETAILED DESCRIPTION OF THE PREFERRED EMBODIMENTS OF THE INVENTION

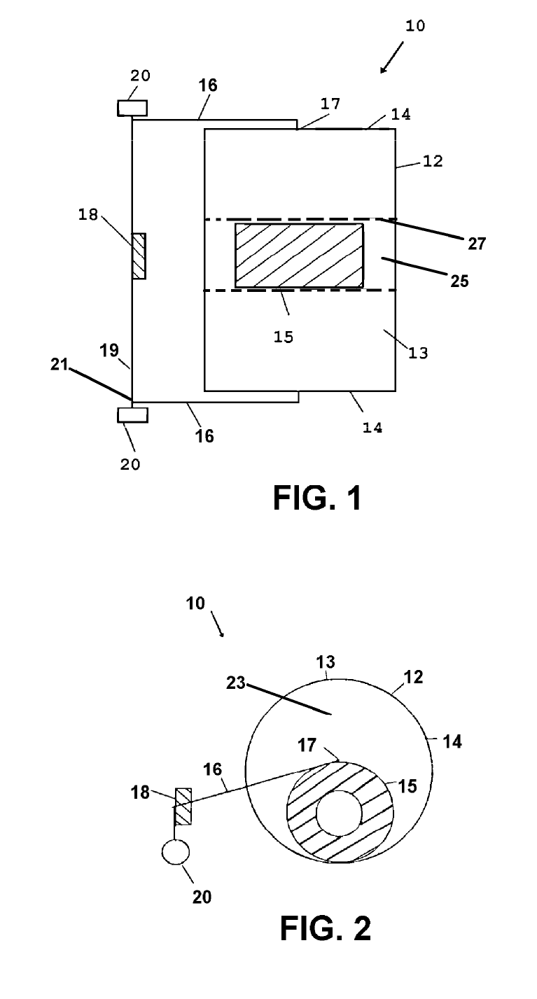

Now referring to drawings in FIGS. 1-8, wherein similar components are identified by like reference numerals, there is seen in FIG. 1 a top view of the device 10. The rim body 12 is an enclosed thin walled cylindrical member which is formed of non-magnetic material such as but not limited to polyethylene or other polymer which also has little or no effect upon a projected magnetic filed from a magnet. The size and diameter of the formed wheel formed by the rim body 12 is defined by the curved surface 13 of a sidewall, and two opposing end surfaces 14 forming end walls on both sides of the formed wheel provided by the rim body 12.

In the following figures the rim body 12 is depicted as transparent for demonstrative purposes but may in fact be opaque due to the nature of the desired material used. However, in some preferred modes herein where the device is intended as a novelty toy item, it may be preferred that the rim body 12 be formed of a transparent polymeric material, such as to allow the user to view the interacting components of the device 10 in the as used mode, for entertainment purposes.

Encapsulated in a centrally located cavity 23 defined by the interior circumference of the rim body 12. Within the cavity 23 is positioned the circular rotor 15 which is formed of a ferromagnetic material such as iron, and rotatable independently of the rim body 12. The rotor 15 is appreciably smaller in diameter then the diameter of the rim body 12 currently between 20 to 70 percent of the diameter of the interior cavity 23.

The control arm 16 is rotatably engaged to the end surfaces 14 of the rim body 12 by a rotatable engagement means 17 such as an axle, located at the center of the end surfaces 14. The control arm 16 extends from the end surfaces 14 forward of the rim body 12 where a magnet securement arm 19 traversing parallel across the rim body 12 is depicted.

It is noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

Further, in this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

A permanent magnet 18, is engaged to a position on or above the securement arm 19 communicating between the two parallel control arms 16, at a position substantially inline with the rotor element 15 which is centered within the cavity 23. The orientation of the magnet 18 thus may be maintained linearly at a fixed distance above the support surface 100 by an elevational means shown currently as a wheel and strut component 21 where wheels 20 rotationally engage with the securement arm 19.

A side view depicting the wheel 20 of the strut component 21 can be seen in FIG. 2. It must be noted that in other modes of the device 10 the permanent magnet 18 may instead be replaced by an electromagnet wherein a battery may be additionally secured thereon to power the former. However, the permanent magnet 18 is preferred due to its relatively high magnetic attraction to ferromagnetic materials.

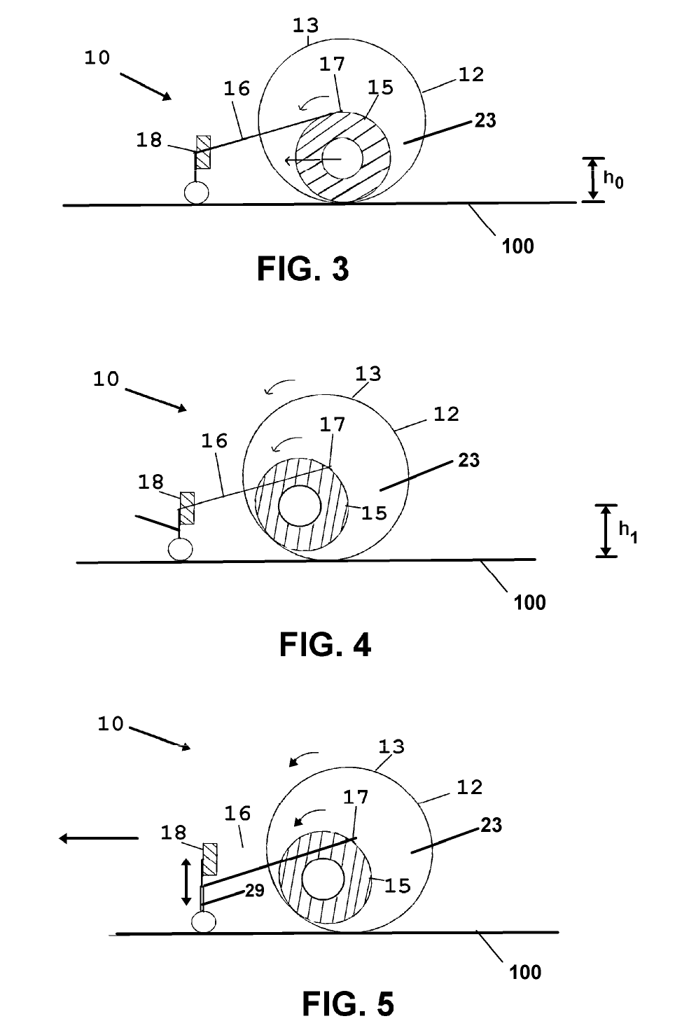

FIG. 3 shows the device 10 in an initial stationary mode. The rotor 15 and rim 12 are considered to have zero kinetic and gravitational potential energy while potential energy is present in the magnetic potential attraction energy between magnet 18 and rotor 15. The attraction causes the rotor 15 to rotate and therefor attempt to move towards the magnet 18. As the rotor 15 rotates, its exterior surface rolls on the circumferential inner wall curved surface 13 of the rim body 12, and it begins to climb the curved surface 13 within the rim body 12. As the rotor 15 climbs, it begins to gain gravitational potential energy due to its increase in elevation above the support surface 100 in its travel along the curved surface 13, as seen in FIG. 4. Briefly, gravitational potential energy in mathematical form is generally known in the art as:

ΔU=mgΔh

where ΔU is the potential energy, m is the mass of the rotor 15, g is acceleration due to gravity, and Δh is the change in elevation, (k₁−h₀).

The presence of the rotor 16 at this increased elevation upon the curved surface 13 of the rim body 12 interior, shifts the center of gravity of the rim body 12 toward the magnet 18 naturally causing it to rotate in that direction as well.

This rotation of the rim body 12, happens in an effort to restore the rotor 15 to a zero gravitational potential energy state (FIG. 3) by an elevation drop of the rotor 12. However, the magnetic attraction restricts the rotor 15 from dropping to a zero gravitational potential and is instead still maintained in rotational motion on the curved surface 13. Therefor, the gravitational potential energy gain is instead translated as kinetic energy by the movement of the rotating rim 12 in its continual attempt to return to a zero potential energy state. Momentum begins to build in the system with the continual repeating of rising of the rotor 15 on the rim body interior since the rotor 15 is continually is attracted to the magnet 18 and will move so long as the magnetic field has sufficient attraction which causes rotation of the rim 12 where again the interplay of gravitational potential, magnetic potential, and kinetic energy is utilized. This continual repositioning of the rotor 15 and then the rim 12, results in a translation of the assembled components forming the device 10 in a direction toward the magnet 18, or along a line running through the center of the rim 12, the rotor 15, and the magnet 18, as shown in FIG. 5.

Also shown in FIG. 5, is a telescopic engagement member 29 providing engagement of the magnet 18 to the securement arm 19. Changing the length of the engagement member 29, allows the magnet 18 to be raised or lowered relative to the support surface 100 and to cause a change in the positioning of the magnetic field. Changing the position of the magnetic field relative to the position of the rotor 15, and relative to the support surface 100, can change the position the rotor 15 reaches in its travel along the interior of the rim 12, relative to the support surface 100. Further, the changing of either the height of the magnet 18, or the strength of the field generated by the magnet 18 singularly or in combination provide a means to change the force and speed of the rotation of the rim 12. Thus the device 10 can be provided with a plurality of magnets 18 in a group with each generating a field of a different strength, and each engageable to one or both of the engagement member 29 or securement member 19. The user can change either component to achieve a change in the positioning of the rotor 15 in its travel upward along the interior of the rim 12, to change the speed or force of the device 10 in its forward travel.

Further depicted in FIG. 5, is a formed track 25 which may be formed on the interior surface of the rim 12 through a depression in the surface shown between the broken lines 27 or a raised portion of the interior surface of the rim 12 at the broken lines 27. While the centering of the magnet between the side edges of the rim 12 will usually generate a magnetic field which attracts the rotor 15 and maintains it substantially centered within the rim 12, it may be desirable to provide the formed track 25 in some cases to further provide a means to maintain the rotor 15 substantially centered between the end surfaces 14 and within the interior of the rim 12.

The device and method herein, coupled to a means to communicate the rotational power provided by the continually rotating rim 12, may be employed to power various mechanical devices requiring rotational energy. For example in a preferred mode, the rotating rim 12 may be engaged to a generator, such as through a gearing of one or both side surfaces 14 with mating engagement to gears on a generator, wherein the rotation of the rim 12 would provide power to do the work of rotating the generator as opposed to driving the translation of the device on a support surface 100. Those skilled in the art will recognize that slight modifications in size and scale of the disclosed device for employing any of the preferred modes of the invention may be required in order to properly employ the device, and are anticipated.

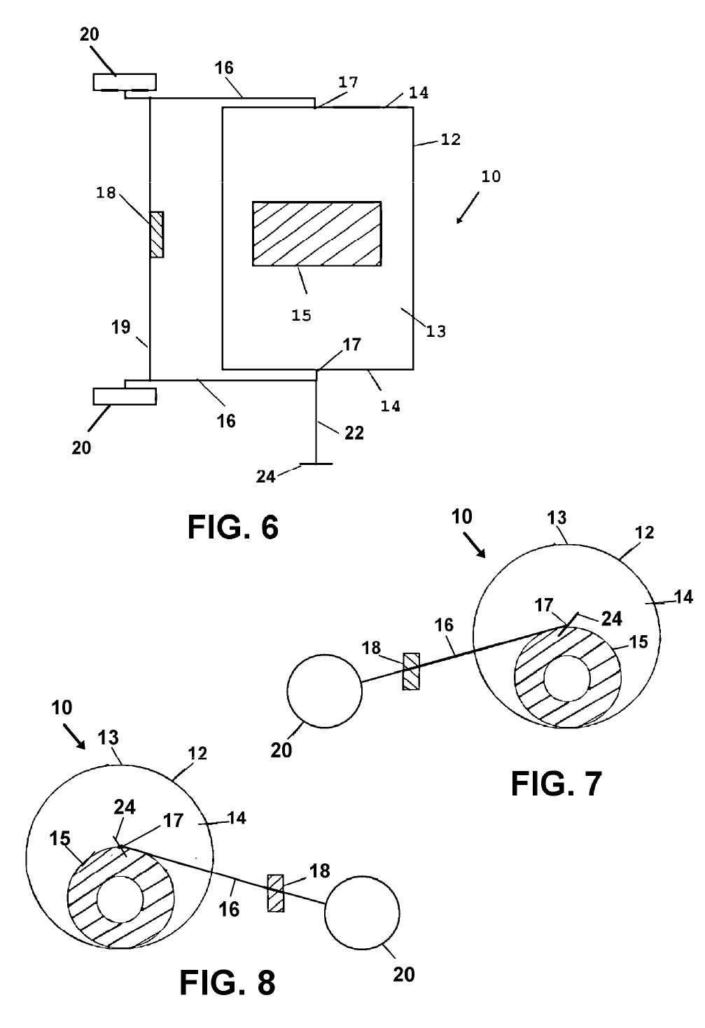

FIG. 6 shows a top view of yet another particularly preferred mode of the device 10 having different control arm, securement arm, and wheel 20 arrangement. This mode of the device 10 is intended to be especially well suited for employment of the forward movement provided by the device 10 as a novelty toy item, and as such may be scaled to a size which is easily manipulated by a users hands. In this mode, the rim 12 again is an enclosed thin walled cylindrical member of non-magnetic material and preferably a transparent light weight polymer, and having a curved surface 13 of a sidewall and end surfaces 14 forming end walls.

Encapsulated in a centrally located circumferentially defined cavity 23 of the rim body 12 is positioned the circular rotor element 15 which is formed of a ferromagnetic material such as iron, and rotatable independently of the rim body 12. For example the rotor 15 can be a caster wheel. Again, the diameter of the rotor 15, as in all modes of the device 10 herein, is appreciably smaller in diameter, then the interior diameter of the rim body 12, for example, between 70 to 20 percent of the diameter of defined cavity 23, formed by the interior surface of the rim body 12. Such has shown to work well in all modes of the device 10.

The control arm 16 in the current mode is rotatably engaged to the end surfaces 14 of the rim body 12 by a rotatable engagement means 17 located at the center of the end surfaces 14. The control arm 16 extends from the end surfaces 14 to the front of the rim body 12 and the rotor element 15 and having substantially large wheels 20 engaged at a distal end thereon such as to elevate the magnet 18 in an operative position without the need for struts as shown in previously modes. Further, the magnet securement arm 19 traversing parallel to the length of the rim body 12 is depicted.

Still further, there is seen a control arm extension member 22 extending from the control arm 16 at or near the engagement means 17 and having a handle 24 engaged at a distal end thereof.

In use to employ the rotation of the device 10 for a toy, as shown in FIG. 7, with the device 10 in a first as-used position with the magnet 18 positioned to the left of, or forward from the rim 12 and rotor 15, the rim 12 will begin to roll and thus translate the entire device 10 in a first direction, that is, toward the magnet 18.

At the user's discretion and for providing entertainment, the user may then grasp the handle 24, for example with their thumb and forefinger, and twist the handle 24, to rotate the positioning assembly formed of the control arm 16, securement arm 19, wheels 20, and magnet 18, in a 180 degree rotation. This rotation positions the magnet 18 on the opposite side of the rim 12 and rotor 15 as shown in FIG. 8. As such, the device 10 will begin to translate in a second direction, that is, toward the new position of the magnet 18, and substantially 180 degrees from the first direction. Therefor the user is provided with a means to actively change direction of the rolling of the device 10, by a twist of the handle 24, which is of great entertainment. This action may be performed for entertainment by a user on a desk top, floor, or other support surface.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An apparatus for imparting rotation to a rim, comprising:
a rim body, said rim body having a circular sidewall, said sidewall having an exterior surface defining a circumference and having an interior surface defining a cavity diameter of an interior cavity;
said rim body having at least one endwall engaged to one side edge of said rim sidewall,
said rim body formed of non ferromagnetic material;
a rotating component having a circular circumference defined by an circumferential surface, said rotating component formed of a ferromagnetic material, and having a diameter sized smaller than said cavity diameter;
said rotating component positioned for a rotation of said circumferential surface in a contact with said interior surface of said sidewall when said exterior surface of said sidewall is positioned upon a support surface;
a magnetic;
means to position said magnet in a first location adjacent to said exterior surface of said rim body; and
said magnet in said first location communicating a magnetic attraction of said rotating element toward said first location;
said magnetic attraction causing said rotation of said circumferential surface upon said interior surface and a relocation of said rotating component from a first position in said contact with said interior surface at a first elevation above said support surface, to a second position in said contact with said interior surface at second elevation above said support surface higher than said first elevation; and
said relocation causing a rotation of said rim body in a direction toward said first position of said magnet, said rotation of said rim body returning said rotating component to substantially said first position, whereby a rolling in a first direction, toward said magnet, may be imparted to said rim body by repeated said relocations of said rotating component from said first position to said second position.

2. The device of claim 1 wherein said means to position said magnet in said first location comprises;
a control arm assembly, said control arm assembly having a control arm rotationally engaged to said sidewall of said rim body and extending to a distal end;
at least one wheel rotationally engaged to said distal end of said control arm;
said magnet engaged to said control arm in said first location; and
whereby said rim body and said wheel are supported on said support surface during said rolling of said rim body toward said magnet.

3. A device of claim 1 further comprising:
means to engage said rim body to a generator whereby power of said rolling of said rim body is communicated to power said generator.

4. The device of claim 2 additionally comprising:
a handle engaged to said control arm;
rotation of said handle in an opposite direction of said roll of said rim causing a repositioning of said magnet to a second position opposite said first position; and
said magnet in said second position causing a reversal in direction of said rolling of said rim.

5. The device of claim 1 wherein said rim is formed of polymeric material.

6. The device of claim 2 wherein said rim is formed of polymeric material.

7. The device of claim 3 wherein said rim is formed of polymeric material.

8. The device of claim 4 wherein said rim is formed of polymeric material.

9. The device of claim 1 wherein said magnet is engaged to said control arm with a telescopic support, said telescopic support allowing for a repositioning of said magnet closer to and further from said support surface; and
said repositioning of said magnet causing a change in a speed of said rolling of said rim.

10. The device of claim 2 wherein said magnet is engaged to said control arm with a telescopic support, said telescopic support allowing for a repositioning of said magnet closer to and further from said support surface; and
said repositioning of said magnet causing a change in a speed of said rolling of said rim.

11. The device of claim 3 wherein said magnet is engaged to said control arm with a telescopic support, said telescopic support allowing for a repositioning of said magnet closer to and further from said support surface; and
said repositioning of said magnet causing a change in a speed of said rolling of said rim.

12. The device of claim 4 wherein said magnet is engaged to said control arm with a telescopic support, said telescopic support allowing for a repositioning of said magnet closer to and further from said support surface; and
said repositioning of said magnet causing a change in a speed of said rolling of said rim.

13. The device of claim 5 wherein said magnet is engaged to said control arm with a telescopic support, said telescopic support allowing for a repositioning of said magnet closer to and further from said support surface; and
said repositioning of said magnet causing a change in a speed of said rolling of said rim.

14. The device of claim 1 wherein a diameter of said rolling component is between 20 and 70 percent of said cavity diameter.

15. The device of claim 2 wherein a diameter of said rolling component is between 20 and 70 percent of said cavity diameter.

16. The device of claim 3 wherein a diameter of said rolling component is between 20 and 70 percent of said cavity diameter.

17. The device of claim 4 wherein a diameter of said rolling component is between 20 and 70 percent of said cavity diameter.

18. The device of claim 9 wherein a diameter of said rolling component is between 20 and 70 percent of said cavity diameter.

19. The device of claim 13 wherein a diameter of said rolling component is between 20 and 70 percent of said cavity diameter.
